(19) United States
(12) Patent Application Publication
(10) Pub. No.: US 2005/0257709 A1
(43) Pub. Date: Nov. 24, 2005

(54) Systems and methods for three-dimensional lithography and nano-indentation

(76) Inventors: Tony Mule, Atlanta, GA (US); Paul Kohl, Atlanta, GA (US); Muhannad Bakir, Atlanta, GA (US); Kevin P. Martin, Atlanta, GA (US); James D. Meindl, Marietta, GA (US); Hiren Thacker, Decatur, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/699,287

(22) Filed: Oct. 31, 2003

Related U.S. Application Data
(60) Provisional application No. 60/498,419, filed on Aug. 28, 2003.

(51) Int. Cl. B41F 1/00

(52) U.S. Cl. 101/494

(57) ABSTRACT

Systems and methods for three dimensional lithography, nano-indentation, and combinations thereof are disclosed. One exemplary three dimensional lithography method, among others, includes: providing a substrate having at least one optical element, wherein the optical element is selected from a refractive element and a diffractive element; disposing a polymer layer on the substrate and the at least one optical element, wherein the polymer layer includes a polymer material selected from a positive-tone polymer material and a negative-tone polymer material; positioning a mask adjacent the polymer layer, wherein the mask does not cover at least one directly exposed portion of the polymer material directly overlaying the at least one element; and exposing the at least one directly exposed portion of the polymer material to optical energy, wherein the optical energy passes through the at least one directly exposed portion of the polymer material and interacts with the element, and the element redirects the optical energy through the polymer material forming at least one area of indirectly exposed polymer material.

### CROSS-REFERENCE TO RELATED APPLICATION

This application claims priority to U.S. provisional application entitled, “Input/Output Leads, Lithography and Nano-Indentations” having Ser. No. 60/498,419, filed on Aug. 28, 2003, and which is entirely incorporated herein by reference.

### STATEMENT REGARDING FEDERALLY SPONSORED RESEARCH OR DEVELOPMENT

The U.S. government may have a paid-up license in this invention and the right in limited circumstances to require the patent owner to license others on reasonable terms as provided for by the terms of MDA972-99-1-0002 awarded by the DARPA.

### TECHNICAL FIELD

This disclosure is generally related to formation of structures in microelectronics, photonics, and MEMS, and more particularly, this disclosure is related to lithography and molding systems and methods for use in microelectronics, photonics, and MEMS applications.

### BACKGROUND

In general, lithography refers to processes for pattern transfer between various media. A lithographic coating is generally a radiation-sensitized coating suitable for receiving a projected image of the subject pattern. Once the image is projected, it is indelibly formed in the coating (e.g., polymer). However, this process can only be used to form two-dimensional structures. With the continuous integration of electronic, optoelectronic, and MEMS technology, there has become a need to form three-dimensional structures. Thus, a heretofore unaddressed need exists in the industry that addresses the aforementioned deficiencies and/or inadequacies.

### SUMMARY

Systems and methods for three dimensional lithography, nano-indentation, and combinations thereof are disclosed. One exemplary three dimensional lithography method, among others, includes: providing a substrate having at least one optical element, wherein the optical element is selected from a refractive element and a diffractive element; disposing a polymer layer on the substrate and the at least one optical element, wherein the polymer layer includes a polymer material selected from a positive-tone polymer material and a negative-tone polymer material; positioning a mask adjacent the polymer layer, wherein the mask does not cover at least one directly exposed portion of the polymer material directly overlaying the at least one element; and exposing the at least one directly exposed portion of the polymer material to optical energy, wherein the optical energy passes through the at least one directly exposed portion of the polymer material and interacts with the element, and the element redirects the optical energy through the polymer material forming at least one area of indirectly exposed polymer material.

One exemplary nano-indentation method, among others, includes: providing a substrate having a polymer layer disposed on the substrate, the polymer layer includes a polymer material that is in an uncured plastic state; providing a stamp mask having a photomask and at least one nano-indentation structure for forming a physical feature on the polymer layer, wherein the photomask does not cover at least one area of the polymer material; and stamping the polymer material with the stamp mask, wherein the polymer material forms the physical feature caused by the at least one nano-indentation structure.

One exemplary method of forming a structure, among others, includes: providing a substrate having at least one element and a polymer layer, the polymer layer is disposed on the substrate and the at least one element, wherein the polymer layer includes a polymer material selected from a positive-tone polymer material and a negative-tone polymer material, wherein the polymer material is in an uncured plastic state, and wherein the element is selected from a refractive element and a diffractive element; providing a stamp mask having a photomask and at least one nano-indentation structure for forming a physical feature on the polymer layer, wherein the photomask does not cover at least one directly exposed portion of the polymer material; stamping the polymer material with the stamp mask, wherein the polymer material forms the physical feature caused by the at least one nano-indentation structure; and exposing the at least one directly exposed portion of the polymer material to optical energy, wherein the optical energy passes through the at least one directly exposed portion of the polymer material and interacts with the element, and the element redirects the optical energy through the polymer material forming at least one area of indirectly exposed polymer material.

Other systems, methods, features, and advantages of this disclosure will be or become apparent to one with skill in the art upon examination of the following drawings and detailed description. It is intended that all such additional systems, methods, features, and advantages be included within this description, be within the scope of this disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIG. 1 is a representative flow chart of an embodiment of a three-dimensional lithography method.

FIG. 2A is a cross-sectional view of a representative embodiment of a structure formed using the three-dimensional lithography method of FIG. 1, while FIG. 2B is another cross-sectional view of the structure of FIG. 1 from the A-A perspective.

FIGS. 3A through 3E are a sequence of cross-sectional views illustrating the formation of the structure shown in FIGS. 2A and 2B.

FIGS. 4A through 4D are a sequence of cross-sectional views illustrating the formation of the structure shown in FIGS. 2A and 2B.

FIG. 5 illustrates a cross-sectional view of a representative tunneled structure using a tunnel system formed by the three-dimensional lithography method of FIG. 1.

FIG. 6 illustrates a cross-sectional view of a representative structure having slanted walls formed using the three-dimensional lithography method of FIG. 1.

FIGS. 7A through 7E are a sequence of cross-sectional views illustrating the formation of the sloped wall structure shown in FIG. 6.

FIG. 8 illustrates a cross-sectional view of a structure having an “L”-shaped polymer pillar formed using the three-dimensional lithography method of FIG. 1.

FIGS. 9A through 9F are a sequence of cross-sectional views illustrating the formation of the structure shown in FIG. 8.

FIGS. 10A and 10B are cross-sectional views illustrating a system using a pair of “L”-shaped polymer pillars.

FIG. 11 illustrates a cross-sectional view of a “W”-tunnel system having a “W”-cross-section formed using the three-dimensional lithography method of FIG. 1.

FIGS. 12A through 12E are cross-sectional views of a representative sequence to form the “W”-tunnel system shown in FIG. 11.

FIG. 13 illustrates a cross-sectional view of “W”-shaped structure formed using the three-dimensional lithography method of FIG. 1.

FIGS. 14A through 14E are a sequence of cross-sectional views illustrating the formation of the “W”-shaped structure shown in FIG. 13.

FIG. 15 is a flowchart depicting functionality of an embodiment of a method using nono-indentation to form physical features in a polymer material.

FIG. 16 illustrates six polymer structures formed using the nano-indentation method of FIG. 15.

FIGS. 17A through 17E are a sequence of cross-sectional views illustrating the formation of the six polymer structures shown in FIG. 16 using the nano-indentation methods of FIG. 15.

FIGS. 18A through 18F are cross-sectional views of various embodiments of nano-indentation physical features that can be formed using the nano-indentation methods of FIG. 15.

FIG. 19 is a cross-sectional view of a structure formed using a combination of the three-dimensional lithography and nano-indentation methods of FIG. 15.

FIGS. 20A through 20D are a sequence of cross-sectional views illustrating the formation of the structure shown in FIG. 19.

### DETAILED DESCRIPTION

Systems and methods for three-dimensional lithography, nano-indentation, and combinations thereof, are described herein. In general, three-dimensional lithography and nano-indentation systems and methods can be used to form structures that are difficult, if not impossible, to form using other techniques. In general, three-dimensional lithography uses optical elements (e.g., mirrors and grating couplers) that are buried within a polymer layer to redirect optical energy to otherwise unexposed regions of the polymer layer to yield three-dimensional structures. In this regard, three-dimensional lithography can be used to form slanted vias, slanted walls, tunnel systems, air-cladding for optical waveguides, non-planar strucutures, RF channels, and combinations thereof. These structures can find application in electrical, optical, and MEMS technologies, for example.

Nano-indentation is a simple and low cost method of transferring a pattern from a mask to a polymer film. In general, a mask is used to plastically deform a polymer. The mask is brought into contact with the polymer prior to curing and at temperatures below the glass transition temperature of the polymer. The mask includes physical features that are imparted onto the polymer. In this regard, nano-indentation can be used to form physical features in a polymer layer such as, but not limited to, structures having curves, structures having slanted walls, small structures, and combinations thereof.

Combining three-dimensional lithography with nano-indentation provides methods of forming structures and devices that are otherwise difficult to fabricate. For example, three-dimensional lithography can be used to form smooth sidewalls, which can be used in optical waveguides. Adding the ability to plastically deform part of the waveguide using nano-indentation to fabricate surface-normal diffractive grating couplers provides a simple fabrication of otherwise difficult to form structures.

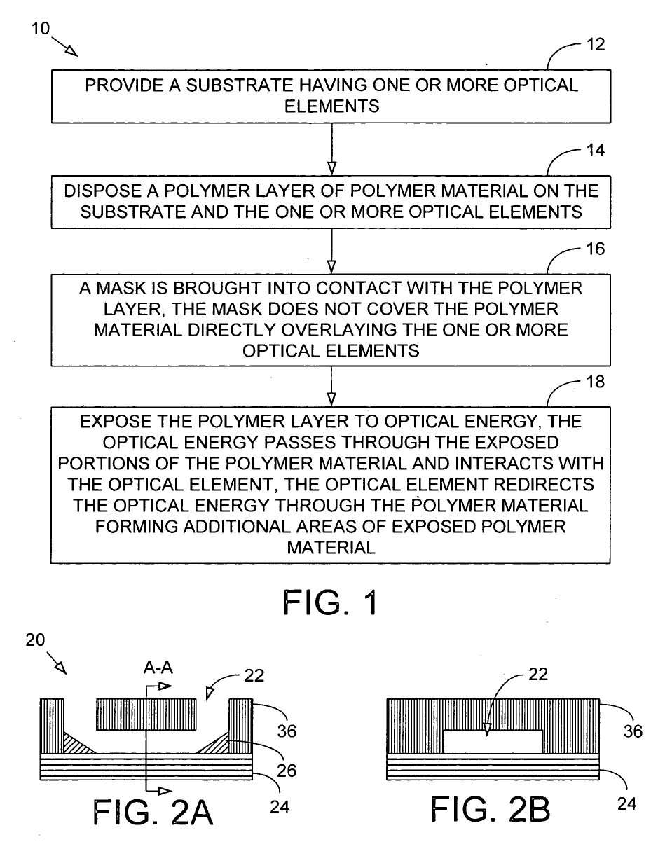

FIG. 1 is a flowchart depicting functionality of an embodiment of a three-dimensional lithographic method 10 of using a three-dimensional lithography system. As shown in FIG. 1, the method may be construed as beginning at block 12, where a substrate having one or more optical elements disposed thereon is provided. The types of optical elements can include, but are not limited to, refractive elements, diffractive elements, and combinations thereof. The optical elements can be constructed to redirect optical energy (e.g. light) at one or more angles between about 0 and 90°. The refractive elements can include, but are not limited to, mirrors. The diffractive elements can include, but are not limited to, volume grating couplers and surface relief grating couplers. The optical elements can be disposed on the substrate using techniques such as, but not limited to, wet etching, dry etching, chemical vapor deposition, spinning and methods of metal deposition such as sputtering and evaporation.

The substrate can include, but is not limited to, a printed wiring board, a printed wiring/waveguide board, and ceramic and non-organic substrates and modules. The substrate can include additional components such as, but not limited to, die pads, leads, input/output components, waveguides, planar waveguides, polymer waveguides, optical waveguides having coupling elements such as diffractive grating couplers or mirrors disposed adjacent or within the optical waveguide, photodectors, and optical sources such as VCSELS and LEDs.

In block 14, a polymer layer of polymer material is disposed on the substrate and the one or more optical elements. The polymer material can include, but is not limited to, photodefinable polymers, photosensitive thermally decomposable polymers, and combinations thereof. The photodefinable polymers and photosensitive thermally decomposable polymers can be either positive-tone polymer materials or negative-tone polymer materials. More specifically, the polymer material can include compounds such as, but not limited to, polyimides, polynorbornenes, polycarbonates, polyethers, polyesters, functionalized compounds of each, and combinations thereof. In addition, the polymer materials can include negative tone photoinitiators (e.g., photosensitive free radical generators) and positive tone photoinitiators (e.g., photoacid generators). The polymer layer can be between about 1 and 500 micrometers in thickness. The polymer layer can be formed on the substrate and optical elements using techniques such as, but not limited to, lamination, spin coating, extrusions, roller coating, and maniscus coating.

In block 16, a mask is brought into contact with the polymer layer. The mask can be designed to cover (e.g., inhibit exposure to optical energy) portions of the polymer material that are not directly above one or more of the optical elements. In addition, the mask can be designed to expose one or more portions not directly above the optical elements depending, in part, upon any other structures to be formed. The mask can be a hard mask or a soft mask.

In block 18, the polymer material not covered by the mask is exposed to optical energy. The optical energy passes through the polymer material and interacts with one or more of the optical elements. The optical element redirects the optical energy through the polymer material. In general, the optical energy is redirected at an angle from the optical element. The angle at which the optical energy is redirected through the polymer material depends, at least in part, on the type and/or construction of the optical element. The number, the type, and position of the optical elements can be used to redirect optical energy to ultimately form various polymer structures, polymer shapes, conduits, and/or tunnel systems. For example, the redirected optical energy can be used to form polymer structures and polymer structures having one or more slanted walls with various types of slopes.

Now having described systems and methods in general, FIGS. 2A and 2B, 3A through 3E, 4A through 4D, 5, 6, 7A through 7E, 8, 9A through 9F, 10A and 10B, 11, 12A through 12E, 13, and 14A through 14E and the accompanying text, describe some embodiments of methods and systems of this disclosure. While embodiments of this disclosure are described in connection with the above noted figures and accompanying text, there is no intent to limit embodiments of this disclosure to these descriptions. On the contrary, the intent is to cover all alternatives, modifications, and equivalents included within the spirit and scope of embodiments of the present invention.

In general, FIGS. 2A and 2B, 3A through 3E, 4A through 4D, 5, 6, 7A through 7E, 8, 9A through 9F, 10A and 10B, 11, 12A through 12E, 13, and 14A through 14E, illustrate various types of structures, shapes, and tunnel systems that can be formed using the three-dimensional lithography methods of FIG. 1 and provided herein, while also illustrating uses of some of these structures.

FIG. 2A is a cross-sectional view of a representative embodiment of a structure 20 having a tunnel system 22 formed therein using the three-dimensional lithography method described herein, while FIG. 2B is a cross-sectional view of the structure 20 in FIG. 2A through the A-A cross-section. The structure 20 includes, but is not limited to, a substrate 24, a polymer layer 36, two optical elements 26, and a tunnel system 22. The substrate 24, the polymer layer 36, and the two optical elements 26 are similar to the substrate, the polymer layer, and the optical elements described above in reference to FIG. 1. The tunnel system 22 can be used as a conduit for fluids, optical energy, and microwave signals when tunnel system 22 is metallically coated, for example. In addition, the tunnel system 22 can provide compliancy to structures (e.g., a lead) disposed above the tunnel on the polymer layer 36. The tunnel system 22 can be from about 5 to 300 micrometers in height, about 1 to 1000 micrometers in width, and 1 to 1000 micrometers in length.

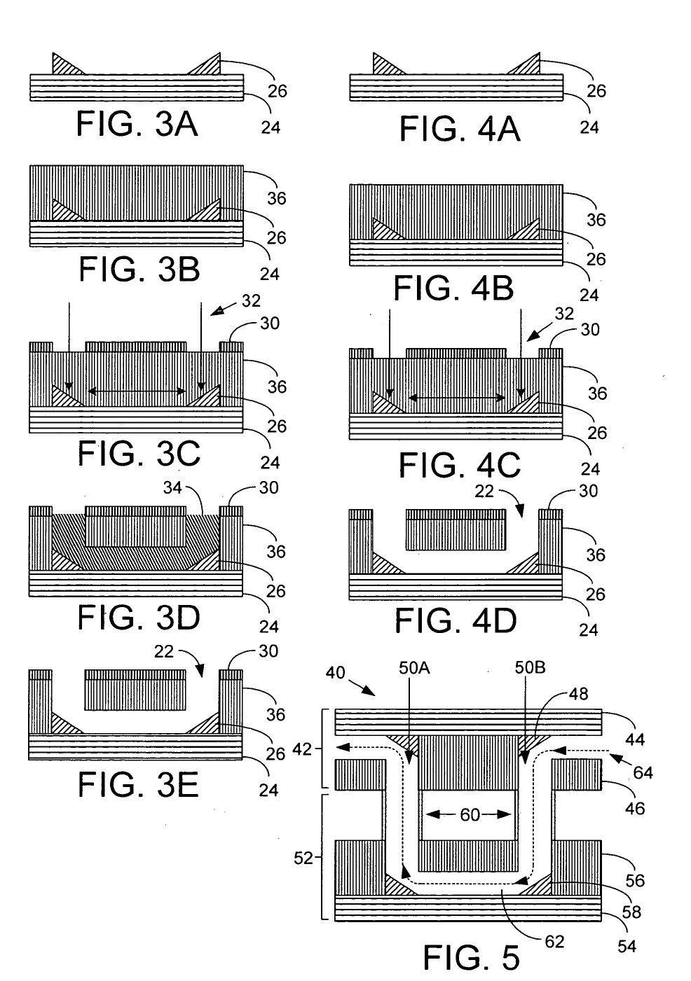

FIGS. 3A through 3E are a sequence of cross-sectional views illustrating the formation of the structure 20 shown in FIGS. 2A and 2B. FIG. 3A illustrates the substrate 24 having two optical elements 26 disposed thereon. FIG. 3B illustrates the formation of a polymer layer 36 on the substrate 24 and the two optical elements 26. The polymer layer 36 includes a photosensitive thermally decomposable polymer material that upon exposure to optical energy is chemically altered into a thermally degradable polymer material. The polymer layer 36 can be formed by techniques such as, but not limited to, lamination, spin coating, extrusions, roller coating, and maniscus coating.

FIG. 3C illustrates a mask 30 being brought into contact with the polymer layer 36 as well as exposure of the mask 30 and polymer layer 36 to the optical energy 32. The optical energy 32 can include ultraviolet energy and infrared energy, which can be generated by mask aligner systems.

The optical energy 32 interacts with the two optical elements 26 and the optical energy 32 is redirected. The area of the polymer material that the optical energy passes through is chemically altered to a thermally degradable polymer 34, as shown in FIG. 3D.

FIG. 3E illustrates the tunnel system shown 22 after the thermally degradable polymer 34 has been degraded. The thermally degradable polymer 34 can be degraded using techniques such as, but not limited to, a furnace, a hotplate, and the like.

FIGS. 4A through 4D are a sequence of cross-sectional views illustrating the formation of the structure 20 shown in FIGS. 2A and 2B. FIG. 4A illustrates the substrate 24 having two optical elements 26. FIG. 4B illustrates the formation of the polymer layer 36 on the substrate 24 and the two optical elements 26. The polymer layer 36 includes a polymer material that upon exposure to optical energy is chemically degradable such as, but not limited to, a photodefinable polymer (e.g., a polymer and a photoacid generator). It should be noted that the polymer material could be a photosensitive thermally decomposable polymer if a thermal decomposition step is added to the method. The polymer layer 36 can be formed by techniques such as, but not limited to, lamination, spin coating, extrusions, roller coating, and maniscus coating. The polymer layer can be from about 5 to 500 micrometers in thickness.

FIG. 4C illustrates a mask 30 brought into contact with the polymer layer 36 as well as the exposure of the mask 30 and polymer material to optical energy 32. The optical energy 32 can include ultraviolet energy and infrared energy, which can be generated by mask aligner systems.

The optical energy 32 interacts with the two optical elements 26 and the optical energy 32 is redirected. The area of the polymer material that the optical energy 32 passes through is chemically degraded, as shown in FIG. 4D, to form the tunnel system shown 22 in FIGS. 2A and 2B.

FIG. 5 illustrates a cross-section of a representative tunneled structure 40 using a tunnel system formed by the three-dimensional lithography method described herein. The tunneled structure 40 includes a first structure 42 and a second structure 52. The first structure 42 includes a substrate 44, a polymer layer 46, and two optical elements 48. The optical elements 48 were used to form two tunnel segments 50A and 50B in the polymer layer 46.

The second structure 52 includes a substrate 54, a polymer layer 56, two optical elements 58, and two hollow structures 60. The optical elements 58 were used to form the tunnel system 62. The two hollow structures 60 are disposed above the portion of the tunnel system 62 above the two optical elements 46 and 58 on each substrate 44 and 54 of the tunneled structure 40. Once the first structure and the second structure are aligned, the two tunnel segments 50A and 50B, the hollow structures 60, and the tunnel system 62 form an interconnected tunnel system. The arrow 64 indicates, for example, how a fluid (e.g. air or liquid) can be flowed through the interconnected tunnel system in the first structure 42 and the second structure 52 to form a fluidic structure. Alternatively, the arrows 64 indicate how optical energy could be directed through the interconnected tunnel system in the first structure 42 and the second structure 52.

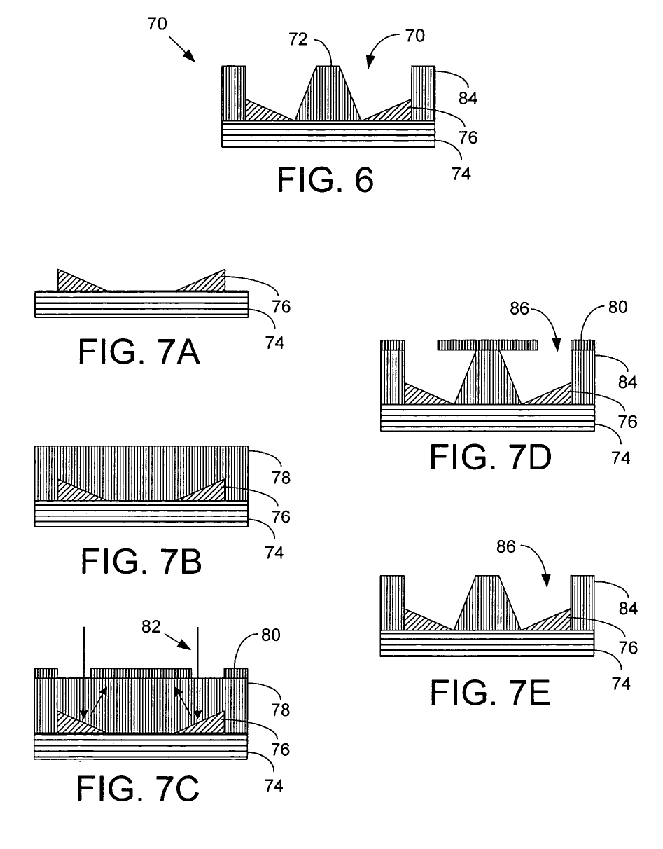

FIG. 6 is a cross-sectional view of a structure 70 having a slanted wall structure 72 formed using the three-dimensional lithography method described herein. The structure 70 includes a substrate 74, two optical elements 76, a polymer layer 84, and a slanted wall structure 72. The substrate 74, two optical elements 76, and the polymer layer 84 are similar to the substrate, two optical elements, and the polymer layer (polymer material) described above in reference to FIG. 1. The slanted wall structure 72 is formed of the same polymer material as the polymer layer 84. The slanted walls of the slanted wall structure 72 have slopes determined, at least in part, by the type and construction (e.g., angle of reflection) of optical elements 76 disposed on the substrate 74. For example, changing the angle of reflection of the optical element 76 could alter the slope of the walls. The structure 70 can be from about 5 to 500 micrometers in height, about 1 to 1000 micrometers in width, and about 1 to 1000 micrometers in length.

FIGS. 7A through 7E are a sequence of cross-sectional views illustrating the formation of the sloped wall structure 72 shown in FIG. 6. FIG. 7A illustrates the substrate 74 having two optical elements 76. FIG. 7B illustrates the formation of the polymer layer 78 on the substrate 74 and the two optical elements 76. The polymer layer 78 includes a polymer material that upon exposure to optical energy is chemically degradable such as, but not limited to, a photodefinable polymer. It should be noted that the polymer material could be a photosensitive thermally decomposable polymer if a thermal decomposition step is added to the method. The polymer layer 78 can be formed by techniques such as, but not limited to, lamination, spin coating, extrusions, roller coating, and maniscus coating.

FIG. 7C illustrates a mask 80 brought into contact with the polymer layer 78 and the exposure of the mask 80 and polymer material to optical energy 82. The optical energy 82 can include ultraviolet energy and infrared energy and can be generated by mask aligner systems.

The optical energy 82 interacts with the two optical elements 76 and the optical energy 82 is redirected. The area of the polymer material that the optical energy 82 passes through is chemically degraded to form an air-region 86, as shown in FIG. 7D. The mask 80 is removed to reveal the slanted wall structure 72 shown in FIG. 6.

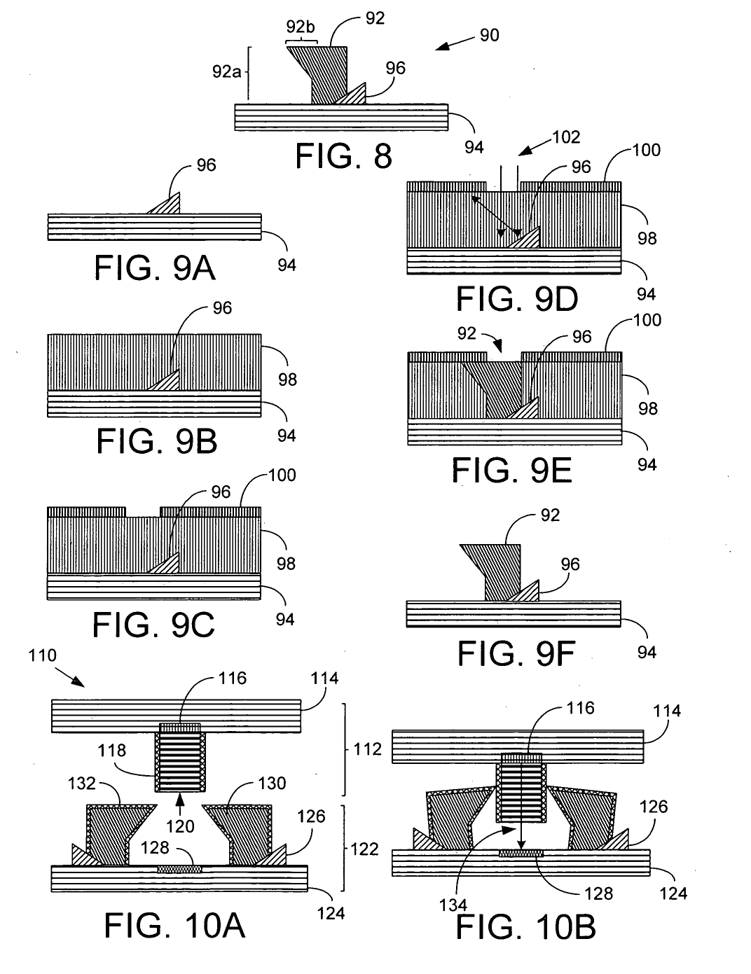

FIG. 8 illustrates a cross-section of a structure 90 having an “L”-shaped polymer pillar 92 disposed thereon. The structure 90 includes a substrate 94, an optical element 96, and the “L”-shaped polymer pillar 92. The substrate 94, the optical element 96, and the polymer material that the “L”-shaped polymer pillar 92 is made of are similar to the substrate, the optical elements, and the polymer material described in reference to FIG. 1.

The “L”-shaped polymer pillar 92 includes a vertical pillar 92a having an upper horizontal portion 92b extending from the top portion of the vertical pillar 92a. The vertical pillar 92a and the upper horizontal portion 92b are formed using a mask, the optical element, and optical energy. The optical energy is redirected by the optical element to form the upper horizontal portion 92b, as discussed in additional detail in reference to FIGS. 9A through 9F.

The “L”-shaped polymer pillar 92 can be from about 10 to 300 micrometers in height, about 2 to 500 micrometers in width, and about 2 to 500 micrometers in length. The upper horizontal portion 92b can be from about 5 to 50 micrometers in length and 2 to 500 micrometers in width.

FIGS. 9A through 9F are a sequence of cross-sectional views illustrating the formation of the structure 90 shown in FIG. 8. FIG. 9A illustrates the substrate 94 having one optical element 96. FIG. 9B illustrates the formation of a polymer layer 98 on the substrate 94 and the optical element 96. The polymer layer 98 includes a polymer material that upon exposure to optical energy is chemically altered into a thermally degradable polymer material. It should be noted that the polymer material could be a photosensitive thermally decomposable polymer if a thermal decomposition step is added to the method. The polymer layer 98 can be formed by techniques such as, but not limited to, lamination, spin coating, extrusions, roller coating, and maniscus coating.

FIG. 9C illustrates a mask 100 brought into contact with the polymer layer 98. FIG. 9D illustrates the exposure of the mask 100 and polymer material to optical energy 102. The optical energy 102 can include ultraviolet energy and infrared energy and can be generated by mask aligner systems

The mask 100 is positioned on the polymer layer 98 so that only a portion of the optical element 96 is directly above the open portion of the mask 100. Thus, when the optical energy 102 passes through the open portion of the mask 100, the optical energy 102 interacts with the exposed portion of optical element 96. The optical energy 102 is redirected at an angle that overlaps with a portion of the vertical polymer material already exposed to the optical energy 102 and also an area that corresponds to where the upper horizontal portion 92b is to be formed. In other words, the combination of exposed areas of the polymer material form an “L”-shape. The exposed “L”-shaped area of the polymer material is chemically altered (e.g., crosslinked) to a thermally stable polymer relative to the unexposed polymer material, as shown in FIG. 9E.

FIG. 9F illustrates the “L”-shaped structure 92 after the polymer layer has been degraded. The polymer layer 98 can be degraded using thermal energy, ultraviolet energy, infrared energy, and the like.

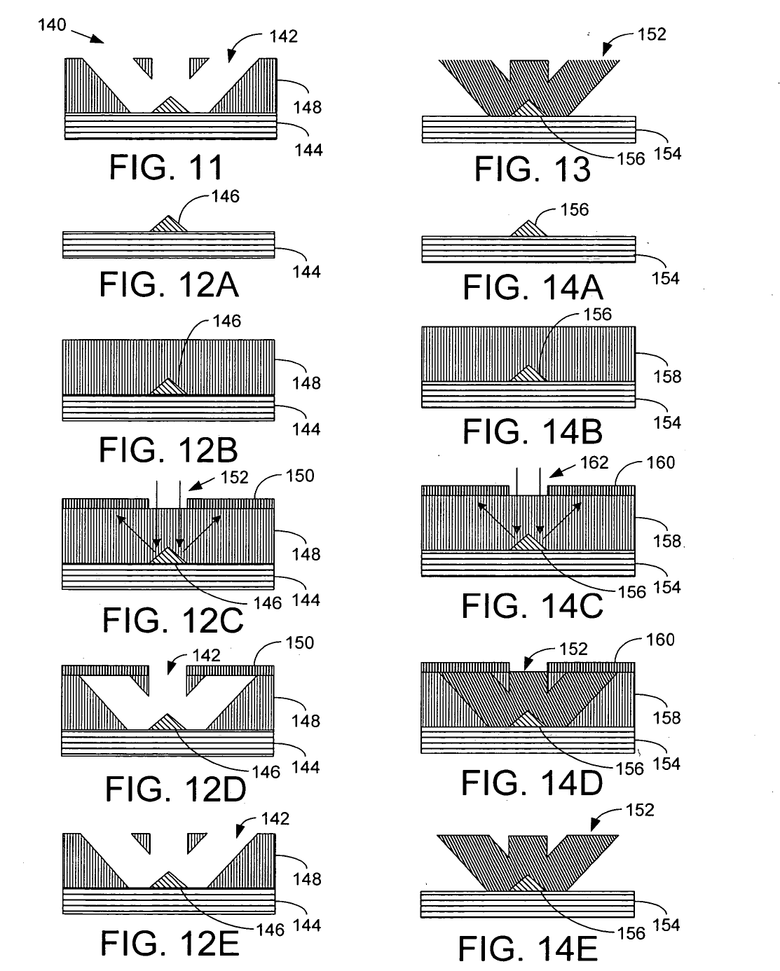

FIGS. 10A and 10B are cross-sectional views of a system 110 using a pair of “L”-shaped polymer pillars. The system 110 includes a first structure 112 and a second structure 122. The first structure 122 includes a substrate 114, a vertical waveguide pillar 118 having a metal layer 120 surrounding the vertical waveguide pillar 118, and an optical source 116. The second structure 122 includes a substrate 124, two optical elements 126, two “L”-shaped polymer pillars 130, and an optical detector 128. The two “L”-shaped polymer pillars 130 have a metal layer 132 surrounding the “L”-shaped polymer pillars 130. The metal layer 120 of the vertical waveguide pillar 118 and the metal layer 132 of the two “L”-shaped polymer pillars 130 can be used to communicate electrical energy. The optical source 116 and the vertical waveguide pillar 118 can be used to guide optical energy 134 from the first structure 112 to the optical detector 128 of the second structure 122. The “L”-shaped polymer pillars 130 can be used to align the vertical waveguide pillar 118 to communicate optical energy 134 from the first substrate 112 to the second substrate 122.

FIGS. 11 and 13 are cross-sections of two structures 140 and 152 that can be fabricated using the three-dimensional lithography methods disclosed herein. FIG. 11 illustrates a “W”-tunnel system 142 having a “W”-cross section, while FIG. 13 illustrates a “W”-shaped structure 152. As discussed in reference to FIGS. 12A through 12E and 14A through 14E, the “W”-tunnel system 142 and the “W”-shaped structure 152 are formed using the same type of optical element 146. However, the polymer material used to form the “W”-tunnel system 142 is a photosensitive positive tone polymer material, while the polymer material used to form the “W”-shaped structure 152 is a photosensitive negative tone polymer material.

The “W”-tunnel system 142 can be about 2 to 1000 micrometers in length, about 2 to 1000 micrometers in width, and about 5 to 300 micrometers in height. The “W”-shaped structure can be about 2 to 1000 micrometers in width, and about 5 to 300 micrometers in height.

FIGS. 12A through 12E are cross-sections of a representative sequence to form the “W”-tunnel system 142 shown in FIG. 11. FIG. 12A illustrates a substrate 144 having one optical element 146. FIG. 12B illustrates the formation of a polymer layer 148 on the substrate 144 and the optical element 146. The polymer layer 148 includes a photosensitive positive-tone polymer material that upon exposure to optical energy is chemically degradable. The polymer layer 148 can be formed by techniques such as, but not limited to, lamination, spin coating, extrusions, roller coating, and maniscus coating.

FIG. 12C illustrates a mask 150 brought into contact with the polymer layer 148 and the exposure of the mask 150 and polymer material to optical energy 152. The optical energy 152 can include ultraviolet energy and infrared energy and can be generated by mask aligner systems.

The optical energy 152 interacts with the optical element 146 and the optical energy 152 is redirected in two directions. The “W”-shaped area of the polymer material that the optical energy 152 passes through is chemically degraded, as shown in FIG. 12D. FIG. 12E illustrates the removal of the mask 152 to reveal the “W”-tunnel system 142 shown in FIG. 11.

FIGS. 14A through 14E are a sequence of cross-sectional views illustrating the formation of the “W”-shaped structure 152 shown in FIG. 13. FIG. 14A illustrates a substrate 154 having one optical element 156. FIG. 14B illustrates the formation of a polymer layer 158 on the substrate 154 and the optical element 156. The polymer layer 158 includes a photosensitive negative-tone polymer material that upon exposure to optical energy is chemically altered into a non-degradable polymer material. Subsequent developing removes the unexposed polymer regions. The material can also be a thermally decomposable material that is also photosensitive. The polymer layer 158 can be formed by techniques such as, but not limited to, lamination, spin coating, extrusions, roller coating, and maniscus coating.

FIG. 14C illustrates the formation of a mask 160 on the polymer layer 158. In addition, FIG. 14D illustrates the exposure of the mask 160 and polymer material 158 to optical energy 162. The optical energy 162 can include ultraviolet energy and infrared energy, which can be generated by mask aligner systems

The optical energy 162 interacts with the optical element 156 and the optical energy 162 is redirected in two directions. The “W”-shaped area of the polymer material that the optical energy 162 passes through is chemically altered to a non-degradable stable polymer material, as shown in FIG. 14D.

The areas not exposed to optical energy 162 are exposed to thermal energy and are degraded as shown in FIG. 14E. The removal of the mask to reveal the “W”-shaped structure shown 152 in FIG. 13. The polymer material can be degraded using thermal energy, ultraviolet energy, infrared energy, and the like.

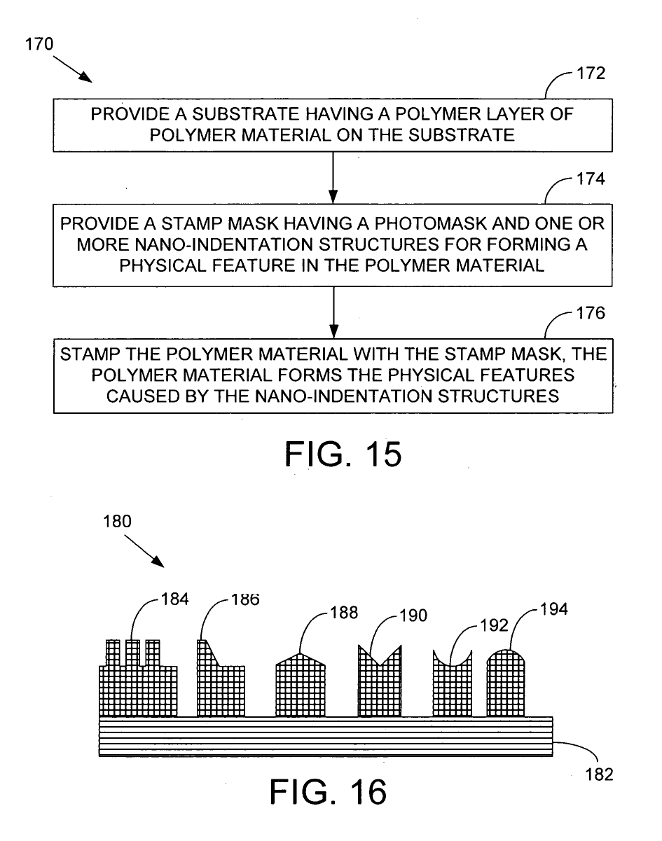

FIG. 15 is a flowchart depicting functionality of an embodiment of a method of using nono-indentation 170 to form physical features in a polymer material. As shown in FIG. 15, the method may be construed as beginning at block 172, where a substrate having a polymer layer disposed thereon. The polymer layer includes a polymer material in an uncured or plastic state such as those described above. The substrate is similar to the substrate discussed in reference to FIG. 1.

In block 174, a stamp mask is provided. The stamp mask includes a photomask and one or more nano-indentation structures for forming a physical feature in the polymer material. The photomask is designed to cover portions of the polymer material and prevent those portions from being exposed to optical energy. The photomask can be made of materials such as, but not limited to, glass, quartz, and the like. The stamp mask can be made of materials such as, but not limited to, glass, quartz, silicon, metals, and other hard materials.

The nano-indentation structures (e.g., molds) are used to stamp physical features into the polymer material disposed on the substrate. The physical features can include, but are not limited to, triangular features, rectangular features, spherical features, elliptical features, and combinations thereof. The physical features can range in size from about 0.01 to 20 micrometers in height, from about 0.01 to 1000 micrometers in width, and from about 0.01 to 1000 micrometers in length.

In block 176, the polymer material is stamped by the stamp mask. The polymer material forms (e.g. molded) into the shape of the physical feature when the stamp mask is stamped into the polymer material. The polymer material molds into the shape of the physical features because the polymer material is in an uncured or plastic state. Subsequently, the molded polymer material can be cured so that the physical features are made permanent.

Alternatively, prior to curing the polymer material, the polymer material can be exposed to optical energy. The optical energy passes through the uncovered areas of the photomask and impinges upon the polymer material thereunder. The polymer material exposed to the optical energy is chemically altered into an unstable polymer material. Subsequently, the molded polymer material can be cured so that the physical features are made permanent and the unstable polymer material is decomposed and removed in one or more steps. Thus, the photomask can be designed to form polymer structures in areas corresponding to the position of the physical features.

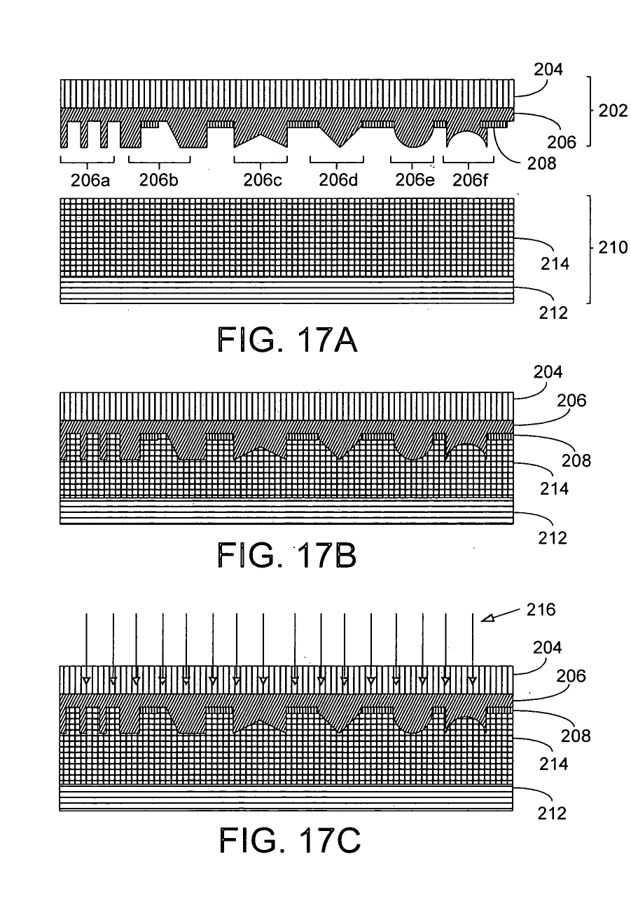

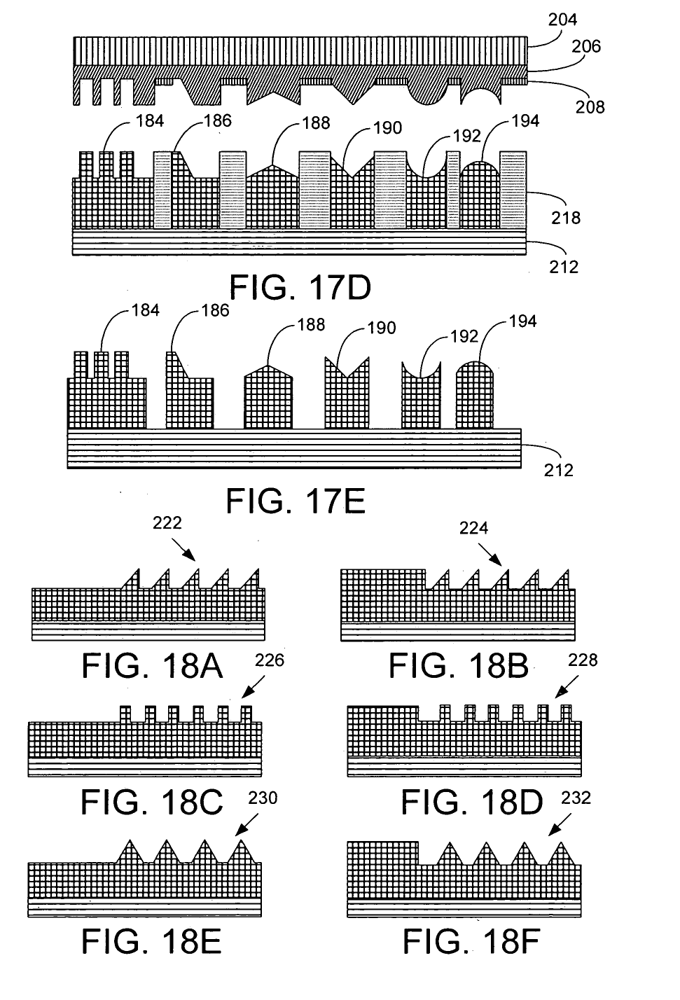

For example, FIGS. 16 and 17A through 17E illustrate six polymer structures 184, 186, 188, 190, 192, and 194 and the method of forming the polymer structures, that can be formed using nano-indentation in conjunction with exposure to optical energy. FIG. 16 illustrates a structure 180 that includes six exemplary structures 184, 186, 188, 190, 192, and 194 disposed on a substrate 182 that can be formed using nano-indentation methods described herein. The six structures include a multi-tooth polymer pillar 184, a “seat” shaped polymer pillar 186, a single point (triangle tip) polymer pillar 188, a double point (inverted triangle tip) polymer pillar 190, a crescent shaped polymer pillar 192, and a half-circle polymer pillar 194. It should be noted that these are only representative structures that can be formed using nano-indentation methods described herein. The structures can be used as optical devices (e.g., grating couplers, mirrors, and lenses) and RF components (filters and electrical devices).

FIG. 17A illustrates a stamping structure 202 and a stamped structure 210. The stamping structure 202 includes a stamp mask 206 disposed onto a structure 204. The stamped structure 210 includes a polymer layer 214 disposed on a substrate 212. The polymer layer 214 includes a polymer material in an uncured or plastic state. The polymer layer 214 can be formed by techniques such as, but not limited to, lamination, spin coating, extrusions, roller coating, and maniscus coating.

The stamp mask 206 includes six sets of nano-indentation structures 206a . . . 206f and a photomask 208. The nano-indentation structures 206a . . . 206f are molds designed to form the multi-tooth physical feature 206a, the “seat” shaped physical feature 206b, the single point (triangle tip) physical feature 206c, the double point (inverted triangle tip) physical feature 206d, the crescent shaped physical feature 206e, and the half-circle physical feature 206f.

FIG. 17B illustrates the stamping of the stamping structure 202 onto the stamped structure 210. The polymer material conforms to the nano-indentation structures 206a . . . 206f to form the physical features described above.

FIG. 17C illustrates the exposure of the polymer material to optical energy 216. The optical energy 216 impinges upon the polymer material that is not covered by the photomask 208 and chemically alters the polymer to a more stable polymer than the unexposed polymer. In particular, the photomask 208 was designed to expose areas of the polymer material inline with the nano-indentation structures 206a . . . 206f so that the polymer structures listed above are formed.

FIG. 17D illustrates the removal of the stamping structure 202 from the stamped structure 210. The physical features are present on the surface of the polymer layer 214. In addition, the areas of unstable polymer material 218 are shown. FIG. 17E illustrates the curing of the stable polymer material and the removal (e.g., decomposition) of the unstable polymer material. The removal of the polymer material reveals the multi-tooth polymer pillar 184, the “seat” shaped polymer pillar 186, the single point (triangle tip) polymer pillar 188, the double point (inverted triangle tip) polymer pillar 190, the crescent shaped polymer pillar 192, and the half-circle polymer pillar 194.

FIGS. 18A through 18F are cross-sections of various embodiments of nano-indentation physical features that can be formed using the nano-indentation methods described herein. FIG. 18A illustrates a right angle saw tooth nano-indentation physical feature 222, while FIG. 18B illustrates a recessed right angle saw tooth nano-indentation physical feature 224. FIG. 18C illustrates a square saw tooth nano-indentation physical feature 226, while FIG. 18D illustrates a square recessed right angle saw tooth nano-indentation physical feature 228. FIG. 18E illustrates a triangle saw tooth nano-indentation physical feature 230, while FIG. 18F illustrates a triangle recessed right angle saw tooth nano-indentation physical feature 232. In particular, the nano-indentation physical features shown in FIGS. 18A through 18F can be used as optical surface relief gratings for surface-normal (or off normal axis) preferential order coupling and focusing.

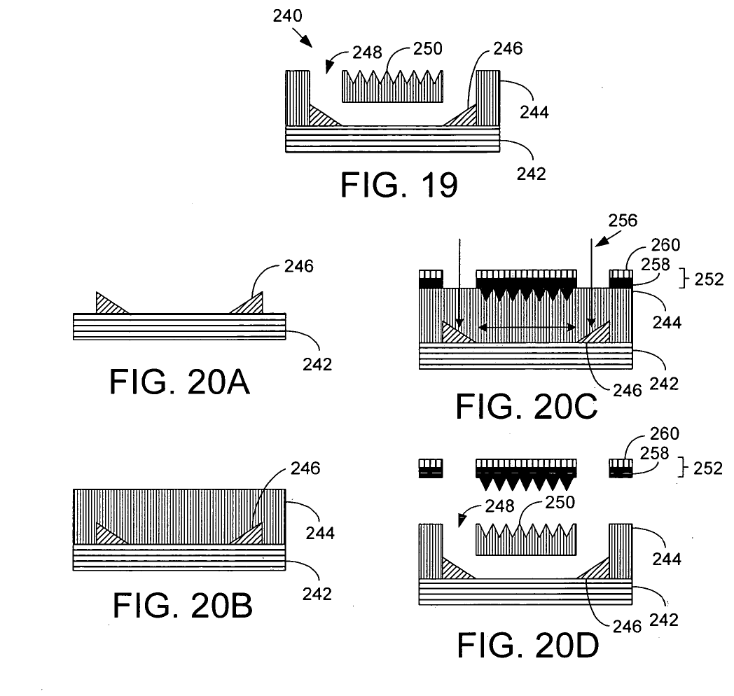

FIG. 19 is a cross-section of a structure 240 formed using a combination of the three-dimensional lithography and nano-indentation methods described herein. The structure 240 includes a substrate 242, a polymer layer 244, two optical elements 246, a tunnel system 248, and a triangle saw tooth nano-indentations physical feature 250. The substrate 242, polymer layer 244, and optical elements 246 are similar to those described in reference to FIG. 1.

FIGS. 20A through 20D are a sequence of cross-sectional views illustrating the formation of the structure 240 shown in FIG. 19. FIG. 20A illustrates the substrate 242 having two optical elements 246. FIG. 20B illustrates the formation of a polymer layer 244 on the substrate 242 and the two optical elements 246. The polymer layer 244 includes a polymer material that upon exposure to optical energy is chemically degradable. The polymer materials are similar to those described hereinabove. The polymer layer 244 can be formed by techniques such as, but not limited to, lamination, spin coating, extrusions, roller coating, and maniscus coating.

FIG. 20C illustrates the stamping of a stamp mask 252 onto the polymer layer 244 and the exposure of the stamp mask 252 and polymer material 244 to optical energy 256. The stamp mask 252 includes a photomask 258 and a nano-indentation structure 260 for forming the saw tooth physical feature in the polymer material. The photomask 260 is designed to cover portions of the polymer material and prevent those portions from being exposed to optical energy 256. The photomask 260 exposes portions of the polymer material directly above the two optical elements 246 through two openings in the photomask 260.

The optical energy 256 can include ultraviolet energy and infrared energy, which can be generated by mask aligner systems. The optical energy 256 passes through the openings of the photomask 252 and interacts with the two optical elements 246. The optical energy 256 is redirected to form the tunnel system 248. The area of the polymer material that the optical energy 256 passes through is chemically degraded, as shown in FIG. 20D. In addition, the stamp mask 252 is removed to reveal the structure shown in FIG. 19.

It should be emphasized that the above-described embodiments of this disclosure are merely possible examples of implementations, set forth for a clear understanding of the principles of this disclosure. Many variations and modifications may be made to the above-described embodiment(s) without departing substantially from the spirit and principles of this disclosure. All such modifications and variations are intended to be included herein within the scope of this disclosure and protected by the following claims.

1. A method of three dimensional lithography, comprising:
providing a substrate having at least one optical element, wherein the optical element is selected from a refractive element and a diffractive element;
disposing a polymer layer on the substrate and the at least one optical element, wherein the polymer layer includes a polymer material selected from a positive-tone polymer material and a negative-tone polymer material;
positioning a mask adjacent the polymer layer, wherein the mask does not cover at least one directly exposed portion of the polymer material directly overlaying the at least one element; and
exposing the at least one directly exposed portion of the polymer material to optical energy, wherein the optical energy passes through the at least one directly exposed portion of the polymer material and interacts with the element, and the element redirects the optical energy through the polymer material forming at least one area of indirectly exposed polymer material.

2. The method of claim 1, wherein the polymer material includes the positive-tone polymer material and further comprises:
removing the at least one area of indirectly exposed polymer material and the at least one directly exposed portion of the polymer material.

3. The method of claim 1, wherein the polymer material includes the positive-tone polymer material and further comprises:
forming tunnels within the polymer material where the at least one area of indirectly exposed polymer material is removed.

4. The method of claim 1, wherein the polymer material includes the positive-tone polymer material and further comprises:
forming slanted polymer layer walls by removing the at least one area of indirectly exposed polymer material.

5. The method of claim 1, wherein the polymer material includes the negative-tone polymer material and further comprises:
removing the polymer material except for the at least one area of indirectly exposed polymer material and the at least one directly exposed portion of the polymer material.

6. The method of claim 1, wherein the polymer material includes the negative-tone polymer material and further comprising:
forming a polymer structure having at least one slanted polymer wall by removing the polymer material except for the at least one area of indirectly exposed polymer material and the at least one directly exposed portion of the polymer material.

7. The method of claim 6, wherein the polymer structure is selected from a “W”-shaped polymer structure and an “L”-shaped polymer structure.

8. A method for nano-indentation, comprising:
providing a substrate having a polymer layer disposed on the substrate, the polymer layer includes a polymer material that is in an uncured plastic state;
providing a stamp mask having a photomask and at least one nano-indentation structure for forming a physical feature on the polymer layer, wherein the photomask does not cover at least one area of the polymer material; and
stamping the polymer material with the stamp mask, wherein the polymer material forms the physical feature caused by the at least one nano-indentation structure.

9. The method of claim 8, further comprising:
exposing the at least one portion of the polymer material to an optical energy to form at least one exposed area of polymer material.

10. The method of claim 9, further comprising:
curing the polymer material, wherein the at least one exposed portion of polymer material is removed, wherein the polymer material not exposed to the optical energy is cured.

11. The method of claim 8, further comprising:
curing the polymer material, wherein the at least one exposed portion of polymer material is cured, wherein the polymer material not exposed to the optical energy is removed.

12. The method of claim 8, further comprising:
forming a polymer structure having the physical feature.

13. The method of claim 8, wherein the physical feature is selected from a multi-tooth physical feature, a “seat” shaped physical feature, a single point (triangle tip) physical feature, a double point (inverted triangle tip) physical feature, a crescent shaped physical feature, and a half-circle physical feature, and combinations thereof.

14. A method of forming a structure, comprising:
providing a substrate having at least one element and a polymer layer, the polymer layer is disposed on the substrate and the at least one element, wherein the polymer layer includes a polymer material selected from a positive-tone polymer material and a negative-tone polymer material, wherein the polymer material is in an uncured plastic state, and wherein the element is selected from a refractive element and a diffractive element;
providing a stamp mask having a photomask and at least one nano-indentation structure for forming a physical feature on the polymer layer, wherein the photomask does not cover at least one directly exposed portion of the polymer material;
stamping the polymer material with the stamp mask, wherein the polymer material forms the physical feature caused by the at least one nano-indentation structure; and
exposing the at least one directly exposed portion of the polymer material to optical energy, wherein the optical energy passes through the at least one directly exposed portion of the polymer material and interacts with the element, and the element redirects the optical energy through the polymer material forming at least one area of indirectly exposed polymer material.

15. The method of claim 14, wherein the polymer material includes the positive-tone polymer material and further comprising:
removing the at least one area of indirectly exposed polymer material and the at least one directly exposed portion of the polymer material.

16. The method of claim 14, wherein the polymer material includes the positive-tone polymer material and further comprising:
forming tunnels within the polymer material where the at least one area of indirectly exposed polymer material is removed.

17. The method of claim 14, wherein the polymer material includes the positive-tone polymer material and further comprising:
forming slanted polymer layer walls by removing the at least one area of indirectly exposed polymer material.

18. The method of claim 14, wherein the polymer material includes the negative-tone polymer material and further comprising:
removing the polymer material except for the at least one area of indirectly exposed polymer material and the at least one directly exposed portion of the polymer material.

19. The method of claim 14, wherein the polymer material includes the negative-tone polymer material and further comprising:
forming a polymer structure having at least one slanted polymer wall by removing the polymer material except for the at least one area of indirectly exposed polymer material and the at least one directly exposed portion of the polymer material, wherein the polymer structure has the physical feature.

20. The method of claim 14, wherein the structure includes a waveguide having surface relief features.

21. The method of claim 14, wherein physical feature is selected from a multi-tooth physical feature, a “seat” shaped physical feature, a single point (triangle tip) physical feature, a double point (inverted triangle tip) physical feature, a crescent shaped physical feature, and a half-circle physical feature, and combinations thereof.
